(19) United States
(12) Patent Application Publication
(10) Pub. No.: US 2007/0009064 A1
(43) Pub. Date: Jan. 11, 2007

(54) Method and apparatus to facilitate transmission of multiple data streams

(76) Inventors: Zhijun Cai, N. Richland Hills, TX (US); Mansoor Ahmed, Fort Worth, TX (US)

Correspondence Address: MOTOROLA, INC., 1303 EAST ALGONQUIN ROAD, IL01/3RD, SCHAUMBURG, IL, 60196, US

(21) Appl. No.: 11/176,108

(22) Filed: Jul. 7, 2005

(51) Int. Cl. H04L 27/20

(52) U.S. Cl. 375/308

(57) ABSTRACT

A first data stream (101) to be transmitted is modulated (102) using quadrature phase shift keyed modulation to provide corresponding first data symbols. Upon determining (102) that at least a second data stream should also be transmitted (which second data stream is discrete with respect to the first data stream), that second data stream is modulated (105) using quadrature phase shift keyed modulation to provide corresponding second data symbols. The first and second data symbols are then combined (106) to provide resultant combined symbols and those combined symbols are then transmitted (107).

### TECHNICAL FIELD

This invention relates generally to the transmission of multiple data streams.

### BACKGROUND

Many modern communication systems are able to convey a plurality of data streams in a fairly simultaneous manner. In a communication system that makes use of Orthogonal Variable Spreading Factor (OVSF) codes, different OVSF codes can be used to differentiate the transmissions of such different data streams. Unfortunately, OVSF codes typically comprise a limited resource in many communication systems. When not all of the data streams require equal treatment (for example, a data stream comprising a voice service may require considerably different system treatment than a data stream that comprises a Session Initiation Protocol message), use of OVSF codes in this fashion can result in a misallocation of this particular communication system resource to the detriment of the real-time needs of one or more system users.

There have been proposals suggesting that secondary scrambling codes might be usefully employed to effect the transmission of data streams comprising such content as Session Initiation Protocol messages. This approach may indeed result in a net savings with respect to OVSF code usage. Unfortunately, this approach will likely also give rise to other concerns and issues. For example, such a use of secondary scrambling codes can give rise to a concurrent problem with respect to interference. For instance, the irregularity of Real-Time Transport Protocol(RTP) and SIP messages even for one user causes high levels of intermittent interference with a small duty cycle for all users. This causes problems with power control loops, retransmission loops, and so forth for all users. In an extreme situation, the occurrence of these messages intended for just one user could drop calls for more than one user.

### BRIEF DESCRIPTION OF THE DRAWINGS

The above needs are at least partially met through provision of the method and apparatus to facilitate transmission of multiple data streams described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention;

FIG. 4 comprises a flow diagram as configured in accordance with various embodiments of the invention; and

FIG. 5 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a first data stream to be transmitted is modulated using quadrature phase shift keyed modulation to provide corresponding first data symbols. Upon determining that at least a second data stream should also be transmitted (which second data stream is discrete with respect to the first data stream), that second data stream is modulated using quadrature phase shift keyed modulation to provide corresponding second data symbols. The first and second data symbols are then combined to provide resultant combined symbols and those combined symbols are then transmitted.

In a preferred though optional approach, this process also accommodates power multiplexing. More particularly, prior to being combined, the first and second data symbols are each scaled using first and second scaling factors, respectively, which are preferably different than one another. In a preferred approach these scaling factors are selected as a function, at least in part, of a desired quality of service level for at least one of the first and second data streams. Also in a preferred though optional approach, a signal can additionally be transmitted that indicates when combined symbols are going to be so transmitted. This signal can comprise, for example, a part of the first data stream if so desired.

So configured, this approach to modulation effectively permits generation of a scalable higher modulation constellation of data symbols. Depending upon the particular configuration used, various effective data rates are provided to thereby accommodate various data streams having different, for example, delay requirements and/or other quality of service requirements. Those skilled in the art will understand and appreciate that this approach can substitute for the use of secondary scrambling codes for such purposes and thereby avoid, at least in part, the interference problems associated with secondary scrambling codes in this context.

These and other benefits may become clearer upon making a thorough review and study of the following detailed description. Referring now to the drawings, and in particular to FIG. 1, a preferred process 100 may comprise a step 101 of providing a first data stream to be transmitted. This first data stream may comprise, for example, voice data such as digitized or vocoded voice, video content, audio content and so forth. Other content examples are certainly possible and it will be understood by those skilled in the art that these teachings are not particularly limited in this regard.

This process 100 then provides for a step 102 of modulating this first data stream using quadrature phase shift keyed modulation to thereby provide resultant first data symbols. Any known (or hereafter-developed) quadrature phase shift keyed modulation technique may be employed as desired as these teachings are not particularly limited or overly sensitive to the selection of any particular approach in this regard. This process 100 then provides the step 103 of determining whether to also transmit at least a second data stream (which, in a preferred approach, is discrete with respect to the first data stream notwithstanding that the content of these two data streams may be unrelated or related). As one illustrative example, when the first data stream comprises voice data the second data stream might comprise non-voice data. As another example, when the first data stream comprises a first sub data stream and the second data stream comprises a second sub data stream, the first and second sub data stream may comprise a complete data stream for a scalable codec. The first sub data stream is the base layer data stream while the second sub stream comprises an enhanced layer data stream.

Pursuant to this approach 100, when at least a second discrete data stream is not available or otherwise requiring transmission, any desired presently existing or hereafter-developed response may follow. For example, in an optional but preferred approach, this state can result in the step 104 of simply transmitting the first data symbols. More particularly, this can comprise transmitting these first data symbols using their present configuration and constellation characterization. Other approaches may be taken as desired and it will be understood and appreciated by those skilled in the art that these teachings are not particularly sensitive to the selection or use of any particular responsive technique in this regard.

When, however, this step 103 of determining whether to also transmit a second data stream determines that such a second data stream is, indeed, to be transmitted, a responsive step 105 can comprise then modulating the second data stream using quadrature phase shift keyed modulation to provide resultant corresponding second data symbols. This process 100 then preferably provides the step 106 of combining the first data symbols with the second data symbols to provided combined symbols. In a preferred approach, however, these combined symbols comprise scalable higher order modulation signals. More particularly, and again as per a preferred approach, these combined symbols comprise N quadrature amplitude modulation symbols (where “N” comprises an integer such as 2, 4, or otherwise).

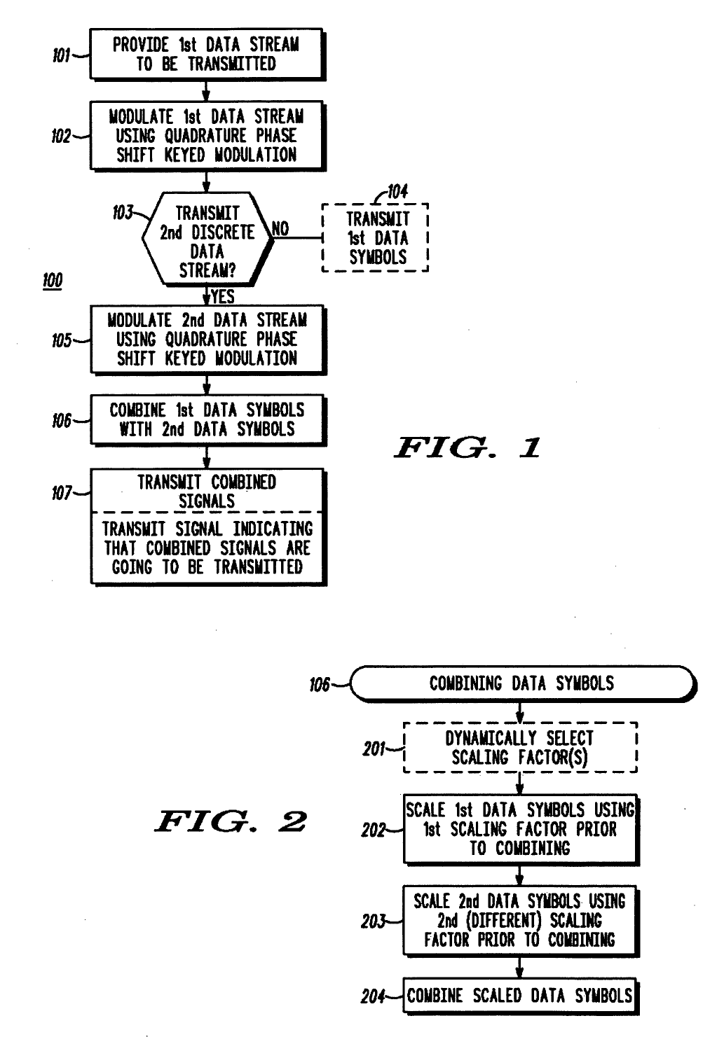

There are various ways by which this combination can be achieved. Referring momentarily to FIG. 2, an optional but illustrative approach to combining these data symbols will now be provided. This illustrative approach to combining data symbols can comprise the step 202 of scaling the first data symbols using a first scaling factor prior to combining the first data symbols with the second data symbols and the step 203 of scaling the second data symbols using a second, different scaling factor prior to combining the first data symbols with the second data symbols.

If desired, and as per an optional but preferred approach, this combination activity can further comprise the step 201 of first dynamically selecting at least one of the first scaling factor and the second scaling factor (as versus, for example, using statically selected or otherwise predetermined values for these factors). This dynamic selection can comprise, for example, dynamic selection of a particular scaling factor from amongst a plurality of available candidate scaling factors. As another example, this dynamic selection can comprise calculating the selected scaling factor based upon one or more dynamic criteria of choice.

In a preferred approach this dynamic selection occurs as a function, at least in part, of a desired quality of service level for at least one of the first data stream and the second data stream. To illustrate this point generally, when the first data stream corresponds to content and/or a particular communication service that requires a higher quality of service level than the second data stream, a higher valued scaling factor may be employed when scaling the first data symbols as compared to the second data symbols. This, in turn, will serve to facilitate power multiplexing with respect to these various data symbol streams during transmission.

In any event, these scaled data symbols are then combined in a corresponding step 204 of this process.

Referring again to FIG. 1, this process 100 then provides the step 107 of transmitting the combined symbols (via, for example, a wireless channel such as a radio frequency, sonic, or optical channel as are known and understood in the art). In an optional but preferred approach, this step 107 of transmitting the combined symbols can also comprise transmitting a signal indicating that combined signals are, in fact, going to be transmitted. For example, this signal can be transmitted as a part of the first data stream (through concatenation, interleaving, or such other technique as may be available and/or desired).

So configured, additional OVSF codes are not required to effect support of differing levels of quality of service for each of a plurality of data stream sources. Instead, these teachings employ higher order modulation to effect this result.

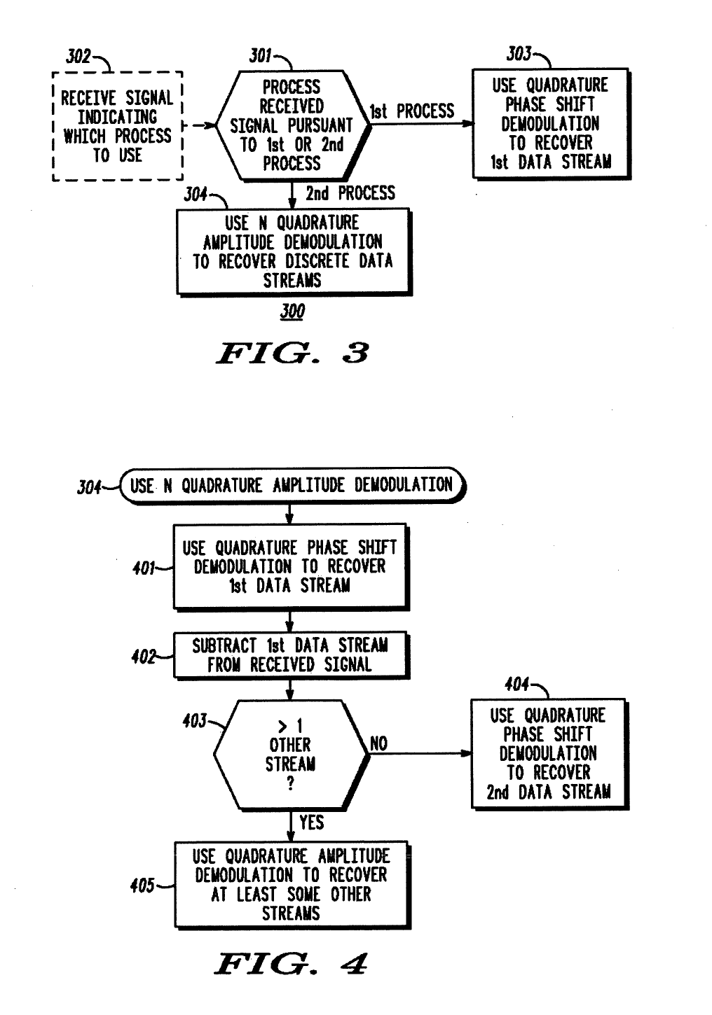

Referring now to FIG. 3, a corresponding illustrative though preferred reception process 300 will be described. In this reception process 300, a receiving platform uses a step 301 of determining whether to process a received signal pursuant, for example, to a first process or a second process. (When a higher number of combination possibilities are supported, those skilled in the art will recognize and understand that a higher number of reception processes may similarly be supported. For the sake of clarity during this illustration, however, only two such process candidates are shown here.)

As noted above, in an optional but preferred approach, the transmitter may source a signal which effectively indicates which process to use (by indicating, for example, whether the transmission comprises a single data stream or a combination of a plurality of data streams). When practiced, this reception process 300 can, in turn, provide for the step 302 of receiving this signal which indicates which process to use. When received, this signal can, in turn, be used to inform the step 301 of determining whether to process the received signal pursuant to a first or a second process.

In this illustrative embodiment, this determination step 301 determines to use the first process when only the first data signals have been sent without being combined with at least a second data stream. In this case, in a preferred approach, this process 300 then provides the step 303 of using quadrature phase shift demodulation to recover the first data stream. The details regarding such demodulation are well understood in the art. Furthermore, these teachings are not overly sensitive to selection of any particular approach in this regard. Accordingly, no further elaboration will be provided here regarding this demodulation step 303.

When deciding, however, to use the second process (as when the transmission comprises a combination of multiple data streams as per the teachings set forth above), this process 300 preferably provides the step 304 of using N quadrature amplitude demodulation (where “N” again comprises an integer) to facilitate recovery of both the first data stream and the second data stream.

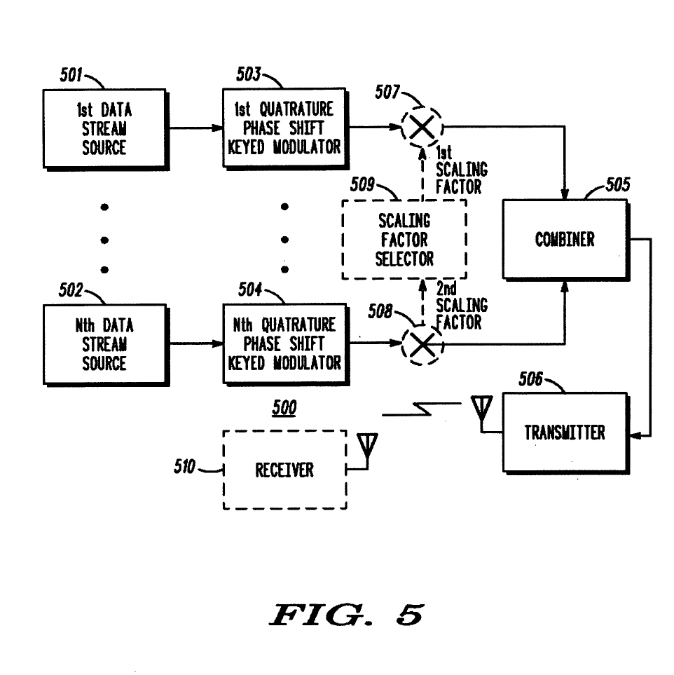

There are various ways to effect this use of N quadrature amplitude demodulation to recover these discrete data streams. Referring now to FIG. 4, by one illustrative approach one provides the step 401 of using quadrature phase shift demodulation to recover the first data stream and then the step 402 of subtracting the recovered first data stream from the received signal. A next step 403 then determines whether there is only one remaining data stream to recover or a larger number of remaining data streams (as when more than two data streams were originally combined).

When only one remaining data stream remains to recover, the step 404 of using quadrature phase shift demodulation to recover the second data stream can be employed. When more than one remaining data stream remains to be recovered, however, this process can preferably provide the step 405 of using quadrature amplitude demodulation to recover at least some of these other streams.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 5, an illustrative approach to such a platform will now be provided.

This apparatus 500 may preferably comprise a first data stream source 501 and at least a second data stream source (illustrated here by an Nth data stream source 502 where “N” again comprises an integer greater than “1”). In a typical and preferred approach at least this first data stream source 501 and this Nth data stream source 502 are different from one another and particularly may differ from one another with respect to a corresponding expected, desired, and/or required level of quality of service. For example, the first data stream source 501 may comprise a voice data source and the Nth data stream source may comprise a non-voice data source as discussed above.

These data stream sources 501 and 502 are operably coupled to corresponding quadrature phase shift keyed modulators 503 and 504 which serve to modulate the incoming data streams. These quadrature phase shift keyed modulators can comprise physically distinct components as is suggested by the illustration or can comprise, for example, a shared resource such as an appropriately configured and/or programmed multiplexed platform. Such design architectural choices are well understood in the art and require no further description here. The outputs of these quadrature phase shift keyed modulators 503 and 504 in turn operably couple to the inputs of a combiner 505.

In a preferred approach this combiner 505 is configured and arranged to output a quadrature phase shift keyed modulated symbol stream that represents the first data stream from the first data stream source 501 when the Nth data stream source provides no data stream (or is otherwise diverted and/or blocked). In a preferred approach this combiner 505 is further configured and arranged to output a higher order quadrature amplitude modulated symbol stream that represents both the first data stream and the Nth data stream when the Nth data stream source provides a data stream (and/or when that Nth data stream is otherwise made available for such combination). A transmitter 506 then receives this combined (or single) data stream content and transmits that content using a transmission medium and technique of choice (such as, but not limited to, a wireless transmission medium).

In a preferred approach, the combiner 505 is further configured and arranged to selectively determine when to output the quadrature phase shift keyed modulated symbol stream and when to output the higher order quadrature amplitude modulated symbol stream as per the teachings set forth herein. Also, optionally but preferably, the combiner 505 (and/or the transmitter 506) is further configured and arranged to provide signaling which, upon reception by a receiver 510, will indicate whether a transmission will comprise the first data stream (alone) or the first data stream as combined with at least the Nth data stream.

The receiver 510, in turn, is preferably configured and arranged to facilitate determining whether to process a received signal pursuant to a first process or at least a second process. For example, and with reference to the teachings set forth above, the first process can comprise using quadrature phase shift demodulation to recover the first received data stream and the second process can comprise using N quadrature amplitude demodulation (where “N” is an integer) to recover both the first received data stream and at least the Nth received data stream.

As noted earlier, these teachings are readily able to facilitate power multiplexing if desired. With continued reference to FIG. 5, this can comprise providing a first scaler 507 through an Nth scaler 508. These scalers 507 and 508 are preferably operably coupled between the quadrature phase shift keyed modulators 503 and 504 and the combiner 505, respectively, and serve to scale the outputs from the quadrature phase shift keyed modulators 503 and 504. For example, the first scaler 507 serves to scale the data symbol output of the first quadrature phase shift keyed modulator 503.

In a preferred approach these scalers 507 and 508 employ different scaling factors. For example, the first scaling factor as is associated with the first scaler 507 may comprise a larger value than the second scaling factor as is associated with the second scaler 508. These differing scaling values may be selected as a function of one or more operational metrics and/or performance criteria of choice. For example, in a preferred approach, such scaling factors may be selected as a function, at least in part, of a desired quality of service level for one or more of the individual discrete data streams. These scaling factors may be selected via, for example, a scaling factor selector 509 as operably couples to such scalers 507 and 508.

Those skilled in the art will recognize and understand that such an apparatus 500 may be comprised of a plurality of physically distinct elements as is suggested by the illustration shown in FIG. 5. It is also possible, however, to view this illustration as comprising a logical view, in which case one or more of these elements can be enabled and realized via a shared platform. It will also be understood that such a shared platform may comprise a wholly or at least partially programmable platform as are known in the art.

It will be understood that these teachings are readily deployable in conjunction with a variety of different signal content and transmission paradigms. These teachings are particularly useful, however, when used in Internet Protocol Multimedia Subsystem (IMS) settings (such as, but not limited to, the support of Voice Over Internet Protocol (VoIP) messages using so-called RAN2 (Radio Access Network Working Group 2) as is being, or has been considered by the Third Generation Partnership Project (3GPP). For example, prior art proposals exist suggesting using secondary scrambling codes when transmitting Real-Time Transport Control Protocol packets or the like in conjunction with an IMS service such a VoIP. As noted earlier, this can lead to unwanted interference problems. The above-described teachings, however, permit one to use multiple Dedicated Channels to generate a scalable higher order of modulation (such as, for example, a derivative of 16 QAM as is known in the art) in lieu of using secondary scrambling codes. By using scalable higher order modulation, the noted performance degradation will more typically be evident only for one code rather than for all codes in use as will more typically characterize the condition which results when employing secondary scrambling codes. In particular, such scalable higher order modulation can be employed to facilitate temporary provision of extra bandwidth for, for example, an IMS data stream while also supporting the transport of additional discrete data content in conjunction therewith.

These teachings can be employed, for example, to effect using quadrature phase shift keyed modulation of each Dedicated Physical Channel which are then weighted (i.e., scaled) and summed prior to spreading via a spreading code as is otherwise known in the art. For example, two such modulated symbols which are summed can be viewed as comprising primary and secondary symbols. Typically, the symbols having the larger scaling influence will preferably comprise the primary symbols with the secondary symbols having the smaller scaling influence. Therefore, for example, IMS data (which typically occurs for a larger percentage of the time) will comprise the primary symbol stream and discrete data occurring less frequently (such as, for example, Session Initiation Protocol messaging) will comprise a secondary symbol stream.

These teachings can therefore be viewed as permitting a way to effect and to leverage the ability to selectively generate higher order symbols coupled with an ability to customize (via scaling) the distance between constellation points of the resultant symbols. This, in turn, permits one to adjust the effective performance of each quadrature phase shift keyed modulation symbol stream separately to thereby accommodate, for example, differing needs and/or expectations regarding corresponding levels of quality of service.

These teachings are therefore seen as allowing one to distinguish between underlying quadrature phase shift keyed modulation symbols as a function, at least in part, of their relative power levels (which in effect may be viewed as a power division multiplexing mechanism). A receiving platform may then, for example, decode the symbol(s) having a higher relative power first and then subtract that decoded result from the total received symbol to yield the lower power symbol(s) which may then be decoded to complete the recovery process. To put it another way, these teachings permit summation of disparate data streams prior to spreading and scrambling. Upon reception, the primary symbols can then be demodulated and decoded in a usual and ordinary fashion without regard to the presence of the secondary symbols. The recovered primary symbols can then be subtracted from the original received content followed by demodulation and decoding of the secondary symbols (which may represent from one to any number of additional discrete data streams).

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing a first data stream to be transmitted;
modulating the first data stream using quadrature phase shift keyed modulation to provide first data symbols;
determining whether to also transmit a second data stream which second data stream is discrete with respect to the first data stream;
upon determining to also transmit the second data stream:
modulating the second data stream using quadrature phase shift keyed modulation to provide second data symbols;
combining the first data symbols with the second data symbols to provide combined symbols;
transmitting the combined symbols.

2. The method of claim 1 wherein the first data stream comprises voice data and the second data stream comprises non-voice data.

3. The method of claim 1 wherein the combined symbols comprise scalable higher order modulation symbols.

4. The method of claim 3 wherein the scalable higher order of modulation symbols comprise N quadrature amplitude modulation symbols, where “N” comprises an integer.

5. The method of claim 1 wherein combining the first data symbols with the second data symbols to provide combined symbols further comprises:
scaling the first data symbols using a first scaling factor prior to combining the first data symbols with the second data symbols;
scaling the second data symbols using a second scaling factor prior to combining the first data symbols with the second data symbols, wherein the second scaling factor is different from the first scaling factor.

6. The method of claim 5 further comprising:
dynamically selecting at least one of the first scaling factor and the second scaling factor.

7. The method of claim 6 wherein dynamically selecting at least one of the first scaling factor and the second scaling factor further comprises selecting at least one of the first scaling factor and the second scaling factor as a function, at least in part, of a desired quality of service level for at least one of the first data stream and the second data stream.

8. The method of claim 1 further comprising, upon determining to also transmit the second data stream, transmitting a signal indicating that combined symbols are going to be transmitted.

9. The method of claim 8 wherein transmitting a signal indicating that combined symbols are going to be transmitted further comprises transmitting the signal as a part of the first data stream.

10. A method comprising:
determining whether to process a received signal pursuant to a first process or a second process;
upon determining to process the received signal pursuant to the first process:
using quadrature phase shift demodulation to recover a first data stream;
upon determining to process the received signal pursuant to the second process:
using N quadrature amplitude demodulation (where “N” is an integer) to recover both the first data stream and at least one other data stream that is discrete with respect to the first data stream.

11. The method of claim 10 wherein determining whether to process a received signal pursuant to a first process or a second process further comprises receiving a signal that indicates which process to use.

12. The method of claim 11 wherein receiving a signal further comprises receiving the signal as part of receiving an earlier transmission of the first data stream.

13. The method of claim 10 wherein using N quadrature amplitude demodulation (where “N” is an integer) to recover both the first data stream and at least one other data stream that is discrete with respect to the first data stream further comprises:
using quadrature phase shift demodulation to recover the first data stream;
subtracting the first data stream from the received signal; and
upon determining only one other stream:
using quadrature phase shift demodulation to recover the second data stream;
upon determining more than one other stream:
using quadrature amplitude demodulation to recover at least some of the other streams.

14. An apparatus comprising:
a first data stream source;
a second data stream source;
a first quadrature phase shift keyed modulator arranged and configured to receive a first data stream from the first data stream source;
a second quadrature phase shift keyed modulator arranged and configured to receive a second data stream from the second data stream source;
a combiner operably coupled to the first and second quadrature phase shift keyed modulator, wherein the combiner is configured and arranged to:
output a quadrature phase shift keyed modulated symbol stream representing the first data stream when the second data stream source provides no data stream; and
output a higher order quadrature amplitude modulated symbol stream representing both the first data stream and the second data stream when the second data stream source provides a data stream;
a transmitter operably coupled to receive the output of the combiner.

15. The apparatus of claim 14 wherein the combiner comprises means for selectively determining when to output the quadrature phase shift keyed modulated symbol stream and when to output the higher order quadrature amplitude modulated symbol stream.

16. The apparatus of claim 14 further comprising:
a first scaler configured and arranged to scale an output from the first quadrature phase shift keyed modulator;
a second scaler configured and arranged to scale an output from the second quadrature phase shift keyed modulator;
wherein the first scaler and the second scaler use different scaling factors.

17. The apparatus of claim 16 further comprising means for selecting the scaling factors as a function, at least in part, of a desired quality of service level for the first data stream and the second data stream.

18. The apparatus of claim 14 further comprising means for signaling to a receiver whether a transmission will comprise the first data stream or the first data stream combined with the second data stream.

19. The apparatus of claim 14 further comprising:
a receiver comprising means for determining whether to process a received signal pursuant to a first process or a second process, wherein the means further comprise means for using quadrature phase shift demodulation to recover a first received data stream upon determining to process the received signal pursuant to a first process and means for using N quadrature amplitude demodulation (where “N” is an integer) to recover both the first received data stream and at least one other received data stream that is discrete with respect to the first received data stream upon determining to process the received signal pursuant to a second process.

20. A method comprising:
providing a first data stream to be transmitted;
determining whether to also transmit a second data stream which second data stream is discrete with respect to the first data stream;
upon determining to also transmit the second data stream, transmitting a signal indicating that the second data stream is going to be transmitted.

21. The method of claim 20 wherein transmitting a signal indicating that the second data stream is going to be transmitted further comprises transmitting the signal as a part of the first data stream.
